(19) United States
(12) Patent Application Publication
(10) Pub. No.: US 2011/0317311 A1
(43) Pub. Date: Dec. 29, 2011

(54) HEAD AND DISK DRIVE WITH THE SAME

(75) Inventor: Hiroaki Kushima, Ome-shi (JP)

(73) Assignee: Kabushiki Kaisha Toshiba, Tokyo (JP)

(21) Appl. No.: 13/100,972

(22) Filed: May 4, 2011

(30) Foreign Application Priority Data
Jun. 23, 2010 (JP) 2010-143153

(51) Int. Cl. G11B 5/60

(52) U.S. Cl. 360/235.7; G9B/5.229

(57) ABSTRACT

According to one embodiment, a head includes a slider including a supporting surface opposed to a surface of a rotatable recording medium, and a head section on the slider, configured to record data on and reproduce data from the recording medium. The supporting surface includes a negative-pressure cavity in the supporting surface to produce a negative pressure, a leading step on an inflow side of the airflow in relation to the negative-pressure cavity, a trailing step on an outflow side of the airflow in relation to the negative-pressure cavity, and including the head section, and a pad provided outside the trailing step at an outflow end part of the negative-pressure cavity, and open in at least one of a central side of the slider and an outflow end side of the slider.

### CROSS-REFERENCE TO RELATED APPLICATIONS

This application is based upon and claims the benefit of priority from Japanese Patent Application No. 2010-143153, filed Jun. 23, 2010; the entire contents of which are incorporated herein by reference.

### FIELD

Embodiments described herein relate generally to a head for use in a disk drive, such as a magnetic disk drive, and a disk drive provided with the head.

### BACKGROUND

A disk drive, such as a magnetic disk drive, comprises a magnetic disk, a spindle motor, a magnetic head, and a carriage assembly. The magnetic disk is provided in a case. The spindle motor supports and rotates the disk. The magnetic head reads and writes data from and to the disk. The carriage assembly supports the head to be movable relative to the disk. The carriage assembly comprises a rotatably supported arm and a suspension extending from the arm, and the magnetic head is supported on an extended end of the suspension. The head comprises a slider mounted on the suspension and a head section mounted on the slider. The head section comprises a reproduction element for reading and a recording element for writing.

The slider has a supporting surface (an air-bearing surface: ABS) opposed to a recording surface of the magnetic disk. The slider is applied with a predetermined head load in a direction toward a magnetic recording layer of the magnetic disk. When the disk drive is actuated, airflow is produced between the rotating disk and slider. Therefore, the supporting surface of the slider is subjected to a force (positive pressure) which causes the slider to fly above the recording surface of the disk, based on the principle of air lubrication. By balancing this flying force and the head load, the slider flies with a gap above the recording surface of the magnetic disk. To prevent fluctuation of a flying amount of the slider, a negative pressure cavity or a dynamic-pressure generation groove is formed near a center of the supporting surface of the slider, in a known disk drive.

That is, the slider comprises a negative pressure groove formed in a center part of the ABS, and a leading pad part provided at an inflow end of the slider, and a trailing pad part provided at an outflow end of the slider. A magnetic head is provided at the trailing pad part.

In common disks, a lubricant is thinly coated on a disk surface to reduce friction caused by contact between a magnetic head and a disk interface. Although a major portion of the lubricant adheres to the disk surface, a slight portion of the lubricant separates from the disk surface and adheres to the supporting surface of the slider. Once the lubricant adheres to the slider, an amount of adhering lubricant gradually increases and exceeds a particular amount. Then, the adhering lubricant drops off the slider onto the disk surface. The lubricant then adheres to the disk surface, forming a protrusion therefrom. If such a protrusion of the lubricant is formed on the disk surface, the magnetic head flies up over a predetermined height from the disk surface when the magnetic head passes above the protrusion, i.e., a so-called high flight occurs. Consequently, there is a case that the magnetic head cannot perform correct writing or reading. Another case can be considered that a liquid drop of the lubricant collides with the head section and damages the head section or magnetic disk.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary plan view showing a HDD according to a first embodiment;

FIG. 2 is an exemplary enlarged side view showing a magnetic head section in the HDD;

FIG. 3 is an exemplary perspective view showing a side of a supporting surface of a slider in the magnetic head;

FIG. 4 is an exemplary enlarged plan view showing the side of the supporting surface of the slider;

FIG. 5 is an exemplary enlarged perspective view showing a pad part of the slider;

FIG. 6 is an exemplary plan view schematically showing airflow on the slider during operation;

FIGS. 7A, 7B, 7C, and 7D are exemplary cross-sectional views showing cross-sections of the slider along a line VII-VII in FIG. 4, in states where an adhering lubricant returns to a side of a magnetic disk;

FIG. 8 is an exemplary perspective view showing a side of a supporting surface of a magnetic head in a HDD according to a second embodiment; and

FIG. 9 is an exemplary plan view showing the side of the magnetic head.

### DETAILED DESCRIPTION

Various embodiments will be described hereinafter with reference to the accompanying drawings.

In general, according to one embodiment, a head comprises a slider comprising a supporting surface opposed to a surface of a rotatable recording medium and configured to fly by airflow produced between the surface of the recording medium and the supporting surface; and a head section on the slider, configured to record data on and reproduce data from the recording medium. The supporting surface of the slider comprises a negative-pressure cavity in the supporting surface to produce a negative pressure; a leading step on an inflow side of the airflow in relation to the negative-pressure cavity; a trailing step on an outflow side of the airflow in relation to the negative-pressure cavity, and comprising the head section; and a pad provided outside the trailing step at an outflow end part of the negative-pressure cavity, and open in at least one of a central side of the slider and an outflow end side of the slider.

A detailed description will now be made below of a first embodiment in which a disk drive is applied to a hard disk drive (HDD).

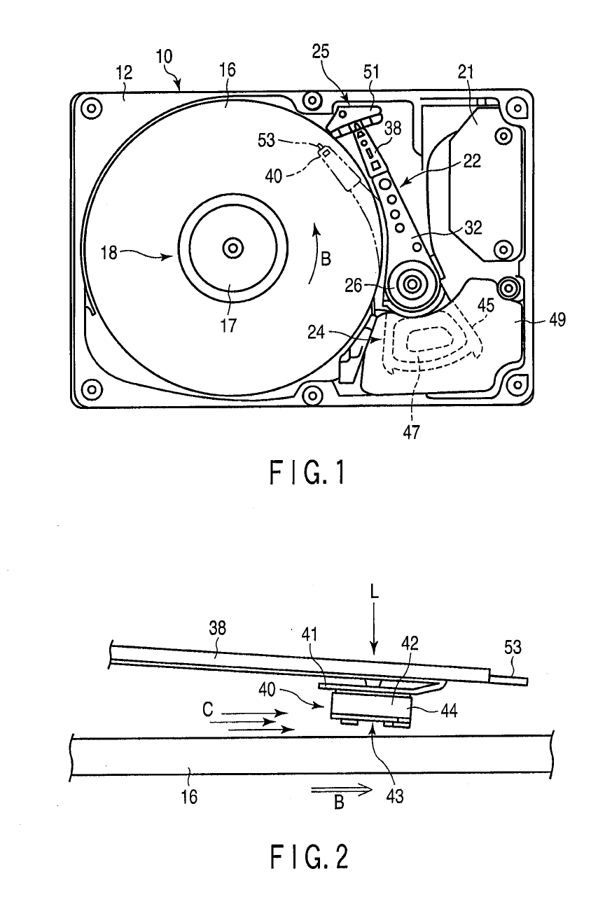

FIG. 1 shows an interior structure of the HDD where a top cover of a casing is disassembled. As shown in FIG. 1, the HDD comprises a casing 10. The casing 10 comprises a base 12 having a rectangular box shape having an open upper surface, and an unillustrated top cover which is secured to the base by plural screws.

In the casing 10, there are provided a magnetic disk 16 as a recording medium, and a spindle motor 18 as a drive section which supports and rotates the magnetic disk. The spindle motor 18 is provided on a bottom wall of the base 12. The magnetic disk 16 is formed to have, for example, a diameter 65 mm (2.5 inches), and comprises magnetic recording layers formed on upper and lower surfaces of the disk. On each of the surfaces of the magnetic disk 16, a lubricant such as oil is coated to be as thin as about 1 mm. In this manner, the magnetic disk 16 is supported to be positioned in parallel with the bottom wall of the base 12. The magnetic disk 16 is rotated at a predetermined speed by the spindle motor 18, e.g., at 5,400 or 7,200 rpm.

The casing 10 contains plural magnetic heads 40, a carriage assembly 22, a voice coil motor (VCM) 24, a ramp load mechanism 25, and a board unit 21. The magnetic heads 40 write data to and read data from the magnetic disk 16. The carriage assembly 22 supports the magnetic heads to be freely movable relative to the magnetic disk 16. The VCM 24 pivots and positions the carriage assembly 22. The ramp load mechanism 25 maintains the magnetic heads at retracted positions apart from the magnetic disk when the magnetic heads are moved to outermost periphery of the disk. The board unit 21 comprises a head IC.

An unillustrated printed circuit board is attached to an outer surface of the bottom wall of the base 12. The printed circuit board controls the spindle motor 18, VCM 24, and magnetic heads 40 through the board unit 21.

The carriage assembly 22 comprises a bearing unit 26 secured to the bottom wall of the base 12, and plural arms 32 extending from the bearing unit. The arms 32 are arranged parallel to the surfaces of the magnetic disk 16 at predetermined intervals, and extend in one same direction from the bearing unit 26. The carriage assembly 22 comprises elastically deformable suspensions 38 each having a shape of an elongated plate. Each suspension 38 is formed of, for example, a plate spring having a proximal end which is secured to a distal end of a corresponding arm 32 by spot welding or bonding and extends from the arm 32. Each suspension 38 may be formed integrally with respectively corresponding arms 32. Each suspension 38 and a corresponding arm 32 constitute a head suspension. The head suspensions and the magnetic heads 40 constitute a head gimbal assembly.

As shown in FIG. 2, each magnetic head 40 comprises a substantially cuboid slider 42 and a read/write head section 44 provided on the slider. Each magnetic head 40 is secured to a gimbal spring 41 on a distal end part of a corresponding suspension 38. The magnetic heads 40 each are applied with a head load L directed to a corresponding surface of the magnetic disk 16 by elasticity of the suspensions 38.

As shown in FIG. 1, the carriage assembly 22 comprises a support frame 45 extending from the bearing unit 26 on an opposite side to the arms. The support frame supports a voice coil 47 which constitutes a part of the VCM 24. The support frame 45 is formed integrally with the outer periphery of the voice coil 47. The voice coil 47 is positioned between a pair of yokes 49 secured to the base 12. The voice coil 47, along with the yokes and an unillustrated magnet secured to one of the yokes, constitutes the VCM 24. When the voice coil 47 is electrically energized, the carriage assembly 22 pivots about the bearing unit 26, and the magnetic heads 40 are thereby moved to and positioned on a desired track of the magnetic disk 16.

The ramp load mechanism 25 comprises a ramp 51 and tabs 53. The ramp 51 is provided on the bottom wall of the base 12, and is located outside the magnetic disk 16. The tabs 53 extend respectively from distal ends of the suspensions 38. When the carriage assembly 22 pivots to a retracted position outside the magnetic disk 16, each tab 53 engages with a ramp surface formed on the ramp 51 and is thereafter pulled up along a slope of the ramp surface, thereby unloading the magnetic heads 40.

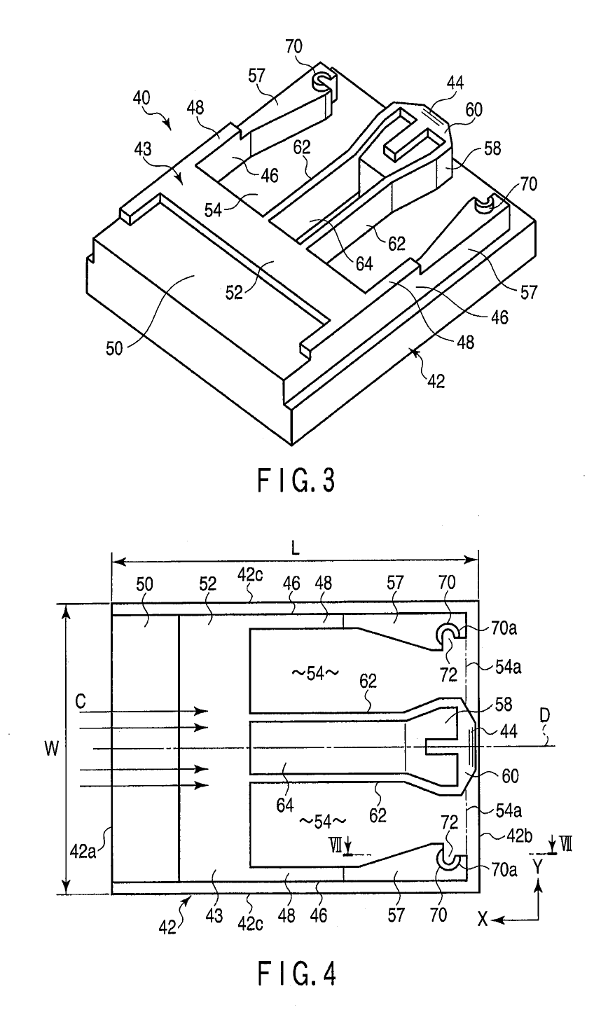

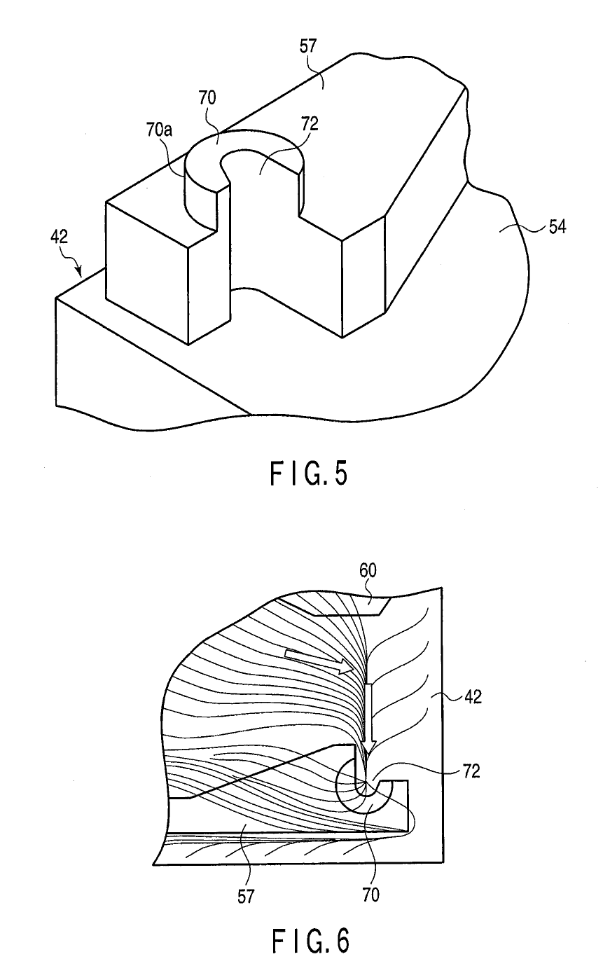

Next, a detailed description will now be made of a configuration of each magnetic head 40. FIG. 3 is an exemplary perspective view showing the slider of the magnetic head. FIG. 4 is an exemplary plan view of the slider, and FIG. 5 is an enlarged perspective view showing a pad part of the slider.

As is shown in FIGS. 3 and 4, each magnetic head 40 comprises the substantially cuboid slider 42, which has a rectangular supporting surface (ABS) 43, an inflow end face 42a, an outflow end face 42b, and a pair of side faces 42c. The supporting surface 43 is configured to face a surface of the magnetic disk 16. The inflow and outflow end faces 42a and 42b extend at right angles to the supporting surface. The side faces 42c extend at right angles to the supporting surface 43 between the inflow and outflow end faces 42a and 42b.

A longitudinal direction of the supporting surface 43 is defined as a first direction X, as well as a transverse direction perpendicular thereto as a second direction Y. The slider 42 is configured as a so-called femto-slider, which has a length L of 1.25 mm or less, e.g., 0.85 mm in the first direction X, and a width W1 of 1.0 mm or less, e.g., 0.7 mm in the second direction Y.

Each magnetic head 40 is configured as a flying head, and the slider 42 is caused to fly by airflow C that is produced between the disk surface and the supporting surface 43 as the magnetic disk 16 rotates. When the HDD operates, the supporting surface 43 of the slider is constantly opposed to the disk surface with a gap maintained from the disk surface. A direction of airflow C is coincident with a direction of rotation B of the magnetic disk 16. The slider 42 is located in a manner that the first direction X of the supporting surface 43 is substantially coincident with the direction of airflow C relatively to the surface of the magnetic disk 16.

As shown in FIGS. 3 and 4, a negative-pressure cavity 54 as a recess is formed, ranging from a substantially central part of the supporting surface 43 to the outflow end side. The negative-pressure cavity 54 opens toward the outflow end face 42b. The slider 42 is formed to be, for example, 0.23 mm thick, and the negative-pressure cavity 54 is formed to be 800 to 1500 nm deep, e.g., 1500 nm deep. By providing the negative-pressure cavity 54, a negative pressure can be produced on the central part of the supporting surface 43 at every feasible yaw angle for the HDD.

A substantially rectangular leading step 50 is formed at an inflow end part of the supporting surface 43. The leading step 50 is one-level (e.g., 100 nm) lower than the supporting surface 43, and protrudes from the bottom surface of the negative-pressure cavity 54. The leading step 50 is positioned in the inflow side of the negative-pressure cavity 54 in relation to the airflow C.

On the supporting surface 43, there are formed a pair of side steps 46 which extend respectively along side edges of the supporting surface 43 and face each other with a gap maintained therebetween in the second direction Y. These side steps 46 protrude from the bottom surface of the negative-pressure cavity 54. The side steps 46 protrude from the leading step 50 to a downstream end side of the slider 42.

On the supporting surface 43, there are formed a pair of skirt parts 57 each of which linearly extends along the first direction X from the side steps 46 to vicinity of the outflow end of the slider. Each skirt part 57 is formed to be deeper than the side steps 46, and protrude from the bottom surface of the negative-pressure cavity 54. Each skirt part 57 is formed, for example, to be 100 to 200 nm deep from the supporting surface 43.

The leading step 50, pair of side steps 46, and pair of skirt parts 57 are arranged symmetrically in relation to a central axis D of the slider 42, and formed in a substantial U-shape as a whole, which is closed on an upstream side and opened on a downstream side. The leading step 50, pair of side steps 46, and pair of skirt parts 57 define the negative-pressure cavity 54.

In order to maintain a pitch angle of each magnetic head 40, a leading pad 52 is provided to support the slider 42 by means of an air film. The leading pad 52 continuously extends throughout a whole width of the leading step 50 in the second direction Y, and is deviated downstream from the inflow end face 42a of the slider 42.

A side pad 48 is formed on each side step 46, and connects with the leading pad 52. The leading pad 52 and side pads 48 are substantially flat and form the supporting surface 43.

The slider 42 comprises a trailing step 58 formed on an outflow end part of the supporting surface 43 in relation to the direction of airflow C. The trailing step 58 protrudes from the bottom surface of the negative-pressure cavity 54, and is formed to have a height of protrusion which is equal to that of the leading step 50. In other words, the trailing step 58 is formed to be as deep from the supporting surface 43 as the leading step 50, i.e., 50 to 250 nm deep or, for example, 100 nm deep. The trailing step 58 is positioned in a downstream side of the negative-pressure cavity 54 in relation to the direction of airflow C, and substantially in a center of the supporting surface 43 in the second direction Y.

The trailing step 58 is formed to be substantially cuboid, two upstream corner parts of which are chamfered. The trailing step 58 has an upper surface opposed to the surface of the magnetic disk 16.

A trailing pad 60 which supports the slider 42 by means of an air film protrudes from the upper surface of the trailing step 58. The trailing pad 60 is formed flush with the leading pad 52, side pads 48, and pads, and has a surface which constitutes the supporting surface 43.

The head section 44 of each magnetic head 40 comprises recording and reproduction elements for recording and reproducing data on and from the magnetic disk 16. These recording and reproduction elements are embedded in a downstream end part of the slider 42 in relation to the direction of airflow C, e.g., in the trailing step 58 in this embodiment. The recording and reproducing elements is provided with a read/write gap formed in the trailing pad 60.

The slider 42 comprises a pair of elongated center rails 62 which extend from the leading step 50 to the trailing step 58. The center rails 62 face each other with a gap maintained between each other in the second direction Y. Between the center rails 62, a guide groove 64 which guides airflow to the trailing step 58 is formed.

As shown in FIGS. 3, and 5, the pad 70 is provided in a negative-pressure producing area of the slider 42, which is at an outflow end 54a of the negative-pressure cavity 54 outside the trailing step 58. In the present embodiment, the pad 70 is provided at an outflow end part of each skirt part 57, and is formed to be substantially as high as the trailing pad 60.

Each pad 70 comprises an opening part 72 which is open in at least one of a central side (low-pressure side) of the slider 42 and an outflow end side of the slider. In the present embodiment, the opening part 72 is open toward both of a central side and an outflow end side. Each pad 70 is formed in a cylindrical shape, and the end edge 70a positioned in the outflow end side of the pad 70 is formed in an arcuate shape.

According to the HDD constructed in this manner, each magnetic head 40 is caused to fly by the airflow C which is produced between the disk surface and the supporting surface 43. Thus, when the HDD operates, the supporting surface 43 of the slider 42 is constantly opposed to the disk surface with a gap maintained from the disk surface. As shown in FIG. 2, each magnetic head 40 flies in such an inclined attitude that the read/write gap of the head section 44 is closest to the disk surface.

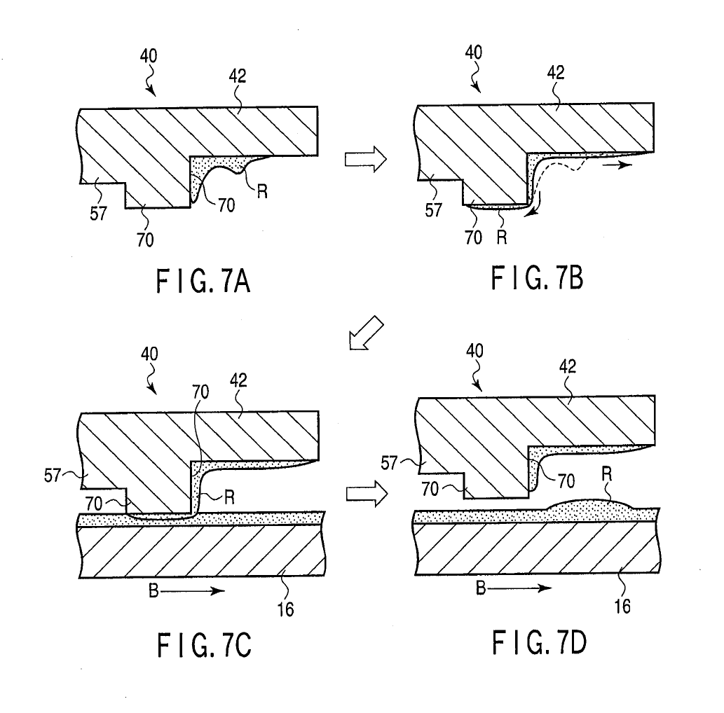

Since the negative-pressure cavity 54 is provided in the supporting surface 43 of the slider 42, each magnetic head 40 can produce a negative pressure on the central part of the supporting surface 43 at every feasible yaw angle for the HDD. Further, the pad 70 is provided in the outflow end side of each skirt part 57, and comprises the opening part 72 directed in a direction toward the central part or outflow end of the slider. Therefore, as schematically shown in FIG. 6, a stagnant point appears near the opening part 72 of the pad 70, and the lubricant which moves and adheres to the slider 42 from above the magnetic disk 16 easily gathers near the opening part 72 of the pad 70 when the head flies. As shown in FIG. 7A, the lubricant R which moves and adheres to the slider 42 is caught by and accumulates in the opening part 72.

When the slider 42 is retracted from above the magnetic disk 16 by unloading of the magnetic head 40, the lubricant R which has been made stay near the pad 70 by an air shearing force is gradually diffused as the lubricant is released from the air force. The lubricant accordingly moves even onto an uppermost surface of the pad 70. When the slider 42 is loaded onto the magnetic disk 16 in this state, the pad makes contact with the magnetic disk 16 over the lubricant, as shown in FIGS. 7C and 7D, and the lubricant on the lubricant is returned to the magnetic disk 16. At this time, the pad 70 makes contact with inside of a load/unload area of the magnetic disk 16, i.e., the outermost peripheral part of the magnetic disk 16. Therefore, there is no risk of data loss caused by contact between the slider 42 and magnetic disk 16. Nor is there a risk of instable flight of the slider 42 due to uneven film thickness of the lubricant which is caused by returning the lubricant R onto the slider 42. Since the end edge 70a of the pad 70 is formed in an arcuate shape, the magnetic disk 16 can be spared from damage even if the pad 70 makes contact with a surface of the magnetic disk 16 when the magnetic head 40 is loaded above the magnetic disk 16.

Further, the lubricant which adheres to the slider 42 can be prevented from neither staying near the trailing pad 60 nor then diffusing to above the head section 44. In this manner, read/write performance immediately after loading can be prevented from deteriorating due to by the lubricant which covers the read/write elements during unloading of the magnetic head 40. Read/write errors can be prevented from being caused by dropping of the lubricant onto a data recording area of the magnetic disk from the slider.

Accordingly, there are provided a head which reduces problems caused by a lubricant and improves in reliability and stability, and a disk drive which comprises the head.

Next, a description will now be made of a magnetic head in a HDD, according to a second embodiment.

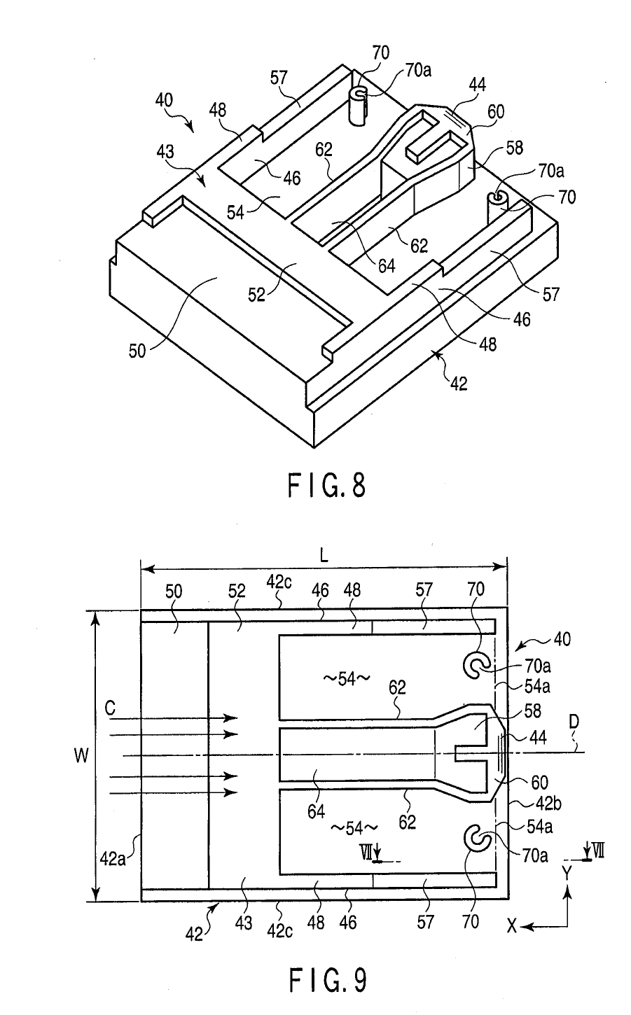

FIG. 8 is a perspective view showing the magnetic head in the HDD, according to the second embodiment. FIG. 9 is a plan view of the magnetic head. As shown in these figures, a slider 42 comprises a pair of pads 70 which are formed to stand on a bottom of a negative-pressure cavity 54, according to the second embodiment. That is, each pad 70 is provided in a negative-pressure producing area of the slider 42, which is at an outflow end 54a of the negative-pressure cavity 54 between a trailing step 58 and a skirt part 57. The pad 70 is formed in a cylindrical shape which is substantially as high as a trailing pad 60.

Each pad 70 has an opening part 72 which is open in at least one of a central side (low-pressure side) of the slider 42 and an outflow end side of the slider. In this embodiment, the opening part 72 is open toward both a central side and an outflow end side. An end edge which is positioned in an outflow end side of each pad 70 is formed in an arcuate shape.

In the second embodiment, other features of structures of the magnetic heads 40 and HDD are the same as those in the first embodiment. Identical parts to both embodiments will be denoted at identical reference symbols, and detailed descriptions thereof will be omitted herefrom.

According to the HDD constructed in a manner as described above, the pads 70 are provided in an outflow end side of the negative-pressure cavity. By providing the pads each with the opening part 72 which is directed in a direction toward a center of the slider or the outflow end, a lubricant which moves and adheres to the slider 42 from above the magnetic disk 16 gathers and stays near the opening parts of the pads 70. When the magnetic heads 40 are loaded, the lubricant can be returned from the pads 70 to the magnetic disk 16. In this manner, the lubricant which adheres to the slider 42 can be prevented from neither staying near the trailing pad nor then diffusing to above the head section 44. Accordingly, read/write performance can be prevented from deteriorating immediately after loading. Read/write errors can also be prevented from being caused by lubricant which drops onto a data recording area of the magnetic disk from the slider.

Accordingly, there are provided a head which reduces problems caused by a lubricant and improves in reliability and stability, and a disk drive which comprises the head.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the pads in the aforementioned sliders are not limited to a cylindrical shape but can be variously modified. The opening parts formed in the pads are not limited to shapes described in the embodiments but can be variously modified. In addition, the opening parts are not limited to a configuration in which the opening parts are open in both of a low-pressure side and an outflow end side but need only be open in one of the low-pressure side and outflow end side. The invention is not limited to femto-sliders but is applicable to pico-sliders, pemto-sliders, or larger sliders. The number of magnetic disks in the disk drive is not limited to one but may be increased.

What is claimed is:

1. A head comprising:
a slider comprising a supporting surface opposed to a surface of a rotatable recording medium and configured to fly by airflow produced between the surface of the recording medium and the supporting surface; and
a head section on the slider, configured to record data on and reproduce data from the recording medium;
the supporting surface of the slider comprising:
a negative-pressure cavity in the supporting surface to produce a negative pressure;
a leading step on an inflow side of the airflow in relation to the negative-pressure cavity;
a trailing step on an outflow side of the airflow in relation to the negative-pressure cavity, and comprising the head section; and
a pad provided outside the trailing step at an outflow end part of the negative-pressure cavity, and open in at least one of a central side of the slider and an outflow end side of the slider.

2. The head of claim 1, wherein the pad is substantially as high as the trailing step.

3. The head of claim 2, wherein the pad comprises an arcuate end edge positioned in the outflow end side.

4. The head of claim 1, wherein the slider comprises a pair of side steps each extending to the outflow end side from the leading step, and a skirt part extending to the outflow end side from the side step, and
the pad is provided at an outflow end of the skirt part.

5. The head of claim 1, wherein the slider comprises a pair of side steps each extending to the outflow end side from the leading step, and a skirt part extending to the outflow end side from the side step, and
the pad is provided between an outflow end of the skirt part and the trailing step.

6. A disk drive comprising:
a disk-type recording medium;
a drive section configured to rotate the recording medium; and
a head comprising a slider comprising a supporting surface opposed to a surface of the recording medium and configured to fly by airflow produced between the surface of the recording medium and the supporting surface; and a head section on the slider, configured to record data on and reproduce data from the recording medium;
the supporting surface of the slider comprising:
a negative-pressure cavity in the supporting surface to produce a negative pressure;
a leading step on an inflow side of the airflow in relation to the negative-pressure cavity;
a trailing step on an outflow side of the airflow in relation to the negative-pressure cavity, and comprising the head section; and
a pad provided outside the trailing step at an outflow end part of the negative-pressure cavity, and open in at least one of a central side of the slider and an outflow end side of the slider.

7. The head of claim 6, wherein the pad is substantially as high as the trailing step.

8. The head of claim 7, wherein the pad comprises an arcuate end edge positioned in the outflow end side.

9. The head of claim 6, wherein the slider comprises a pair of side steps each extending to the outflow end side from the leading step, and a skirt part extending to the outflow end side from the side step, and
the pad is provided at an outflow end of the skirt part.

10. The head of claim 6, wherein the slider comprises a pair of side steps each extending to the outflow end side from the leading step, and a skirt part extending to the outflow end side from the side step, and
the pad is provided between an outflow end of the skirt part and the trailing step.
